(19) United States
(12) Patent Application Publication
(10) Pub. No.: US 2025/0317686 A1
(43) Pub. Date: Oct. 9, 2025

(54) Semiconductor Device And Electronic Apparatus

(71) Applicant: SEIKO EPSON CORPORATION, Tokyo (JP)

(72) Inventors: Toshihiko MORIGAKI, Chino (JP); Fumihito BAISHO, Kai (JP); Tsutomu NONAKA, Hino (JP)

(21) Appl. No.: 19/170,223

(22) Filed: Apr. 4, 2025

(30) Foreign Application Priority Data
Apr. 5, 2024 (JP) 2024-061273

(51) Int. Cl. H04R 3/04; H04R 17/00

(52) U.S. Cl. CPC H04R 3/04; H04R 17/00

(57) ABSTRACT

A semiconductor device includes a sound data reading circuit that reads sound data from a memory, a first pulse width modulation signal generation circuit that generates a first pulse width modulation signal whose pulse width changes based on the sound data, and a second pulse width modulation signal generation circuit that generates a second pulse width modulation signal whose pulse width changes based on the sound data, wherein the first pulse width modulation signal is a signal for a first sound output unit including a first piezoelectric element and a first diaphragm to output a sound, and the second pulse width modulation signal is a signal for a second sound output unit including a second piezoelectric element and a second diaphragm and having a higher resonance frequency than the first sound output unit to output a sound.

The present application is based on, and claims priority from JP Application Serial Number 2024-061273, filed Apr. 5, 2024, the disclosure of which is hereby incorporated by reference herein in its entirety.

### BACKGROUND

### 1. Technical Field

The present disclosure relates to a semiconductor device and an electronic apparatus.

### 2. Related Art

JP-A-2021-072465 describes a circuit device having a PWM signal output circuit that outputs, to a sound output unit, a PWM signal based on pseudo sound data using harmonics belonging to a frequency band that can be output by the sound output unit among a plurality of harmonics of a root belonging to a frequency band lower than a lower limit of the frequency band that can be output by the sound output unit. According to the circuit device described in JP-A-2021-072465, a sound in the lower frequency band that cannot be originally output by the sound output unit is output in a pseudo manner by using the harmonics thereof, and thus high-quality sound reproduction can be performed.

JP-A-2021-072465 is an example of the related art.

In the circuit device described in JP-A-2021-072465, although the sound in the lower frequency band is output in the pseudo manner, the sound in the lower band is not actually output and there is room for improvement for high-quality sound reproduction.

### SUMMARY

A semiconductor device according to an aspect of the present disclosure includes a sound data reading circuit that reads sound data from a memory, a first pulse width modulation signal generation circuit that generates a first pulse width modulation signal whose pulse width changes based on the sound data, and a second pulse width modulation signal generation circuit that generates a second pulse width modulation signal whose pulse width changes based on the sound data, wherein the first pulse width modulation signal is a signal for a first sound output unit including a first piezoelectric element and a first diaphragm to output a sound, and the second pulse width modulation signal is a signal for a second sound output unit including a second piezoelectric element and a second diaphragm and having a higher resonance frequency than the first sound output unit to output a sound.

An electronic apparatus according to an aspect of the present disclosure includes the semiconductor device according to the aspect, the first sound output unit, and the second sound output unit.

### BRIEF DESCRIPTION OF THE DRAWINGS

FIG. 1 shows a configuration example of a semiconductor device and a sound reproduction apparatus according to a first embodiment.

FIG. 2 shows a configuration example of a booster circuit.

FIG. 3 is a perspective view of a sound output unit.

FIG. 4 is a cross-sectional view of the sound output unit.

FIG. 5 shows an example of a relationship between human voice characteristics and sound reproduction characteristics of the sound output unit.

FIG. 6 shows an example of pulse width modulation signals.

FIG. 7 shows a configuration example of a semiconductor device and a sound reproduction apparatus according to a second embodiment.

FIG. 8 shows a configuration example of a semiconductor device and a sound reproduction apparatus according to a modification example.

FIG. 9 shows a configuration example of a semiconductor device and a sound reproduction apparatus according to another modification example.

FIG. 10 is a functional block diagram showing a configuration example of an electronic apparatus using the semiconductor device of the first embodiment.

FIG. 11 is a functional block diagram showing a configuration example of an electronic apparatus using the semiconductor device of the second embodiment.

### DESCRIPTION OF EMBODIMENTS

Hereinafter, preferred embodiments of the present disclosure will be described in detail using the drawings. Note that the embodiments to be described below do not unduly limit the present disclosure described in Claims. In addition, not all configurations to be described below are necessarily component elements of the present disclosure.

### 1. Semiconductor Device and Sound Reproduction Apparatus

### 1-1. First Embodiment

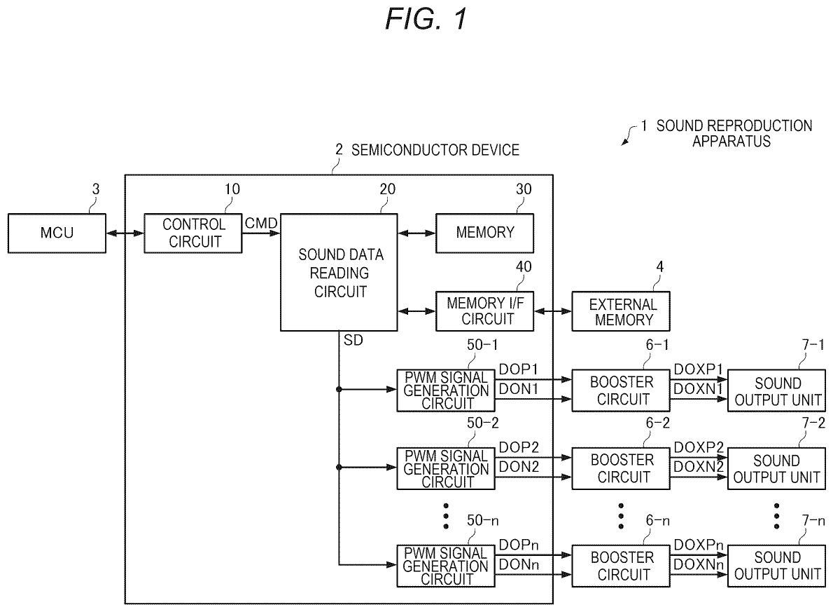

FIG. 1 shows a configuration example of a semiconductor device 2 and a sound reproduction apparatus 1 according to a first embodiment. As shown in FIG. 1, the sound reproduction apparatus 1 includes the semiconductor device 2, an MCU 3, an external memory 4, n booster circuits 6-1 to 6-n, and n sound output units 7-1 to 7-n. The MCU is an abbreviation for Micro Controller Unit. n is an integer of two or more.

As shown in FIG. 1, the semiconductor device 2 is coupled to the MCU 3, the external memory 4, and n booster circuits 6-1 to 6-n, and includes a control circuit 10, a sound data reading circuit 20, a memory 30, a memory interface circuit 40, and n pulse width modulation signal generation circuits 50-1 to 50-n. The semiconductor device 2 may be a one-chip semiconductor integrated circuit device, may include a plurality of chips of semiconductor integrated circuit devices, or may include electronic components at least partially not semiconductor integrated circuit devices.

The memory 30 is a memory built in the semiconductor device 2 and stores a plurality of pieces of sound data. The memory 30 is a nonvolatile memory or a semiconductor memory such as a RAM. The RAM is an abbreviation for Random Access Memory. When the memory 30 is a nonvolatile memory, the plurality of pieces of sound data may be written in the memory 30 in advance.

The external memory 4 stores a plurality of pieces of sound data. The external memory 4 is a nonvolatile memory or a semiconductor memory such as a RAM. When the external memory 4 is a nonvolatile memory, the plurality of pieces of sound data may be written in the external memory 4 in advance. The memory interface circuit 40 is an interface circuit that reads data from the external memory 4.

The various types of sound data stored in the memory 30 and the external memory 4 may be, for example, voice data such as attention calling or guidance, or audio data such as a melody.

The sound data reading circuit 20 reads sound data from the memory 30, and commonly outputs the read sound data as sound data SD to the pulse width modulation signal generation circuits 50-1 to 50-n. Alternatively, the sound data reading circuit 20 reads sound data from the external memory 4 via the memory interface circuit 40, and commonly outputs the read sound data as sound data SD to the pulse width modulation signal generation circuits 50-1 to 50-n. Specifically, the sound data reading circuit 20 transmits a reading command to the external memory 4 via the memory interface circuit 40, and the external memory 4 outputs sound data designated by the reading command. The sound data reading circuit 20 acquires the sound data output from the external memory 4 via the memory interface circuit 40, and commonly outputs the acquired sound data as the sound data SD to the pulse width modulation signal generation circuits 50-1 to 50-n. The sound data SD is data of a predetermined number of bits whose value changes in time series in a sampling period.

The control circuit 10 controls the sound data reading circuit 20. Specifically, the control circuit 10 communicates with the MCU 3 outside the semiconductor device 2, and outputs a command CMD to the sound data read circuit 20 in accordance with an instruction of the MCU 3. For example, the control circuit 10 outputs a command CMD for instructing to read predetermined sound data from the memory 30 to the sound data reading circuit 20, and the sound data reading circuit 20 reads sound data designated by the command CMD from the memory 30 and commonly outputs the read sound data as sound data SD to the pulse width modulation signal generation circuits 50-1 to 50-n. Alternatively, the control circuit 10 outputs a command CMD for instructing to read predetermined sound data from the external memory 4 to the sound data reading circuit 20, and the sound data reading circuit 20 reads the sound data designated by the command CMD from the external memory 4 via the memory interface circuit 40, and commonly outputs the read sound data as the sound data SD to the pulse width modulation signal generation circuits 50-1 to 50-n.

The pulse width modulation signal generation circuit 50-i generates pulse width modulation signals DOPi and DONi whose pulse widths change based on the sound data SD. For example, the pulse width modulation signal generation circuit 50-1 generates pulse width modulation signals DOP1 and DON1 based on the sound data SD, and the pulse width modulation signal generation circuit 50-2 generates pulse width modulation signals DOP2 and DON2 based on the sound data SD. The pulse width modulation signals DOPi and DONi are respectively digital signals, and for example, the pulse width modulation signal DOPi and the pulse width modulation signal DONi are signals whose logic levels are inverted from each other. For example, the pulse width modulation signal generation circuit 50-i may generate the pulse width modulation signals DOPi and DONi based on table information in which a correspondence relationship between a value of data of a predetermined number of bits input as the sound data SD and a logical value of a predetermined number of bits of the pulse width modulation signals DOPi and DONi is defined. The table information is stored in advance in, for example, a nonvolatile memory (not shown). The pulse width modulation signals DOPi and DONi are signals whose duty ratios change with respect to each sampling period of the sound data SD. The duty ratio is a ratio between a high level and a low level. Hereinafter, “pulse width modulation” is referred to as “PWM”.

The PWM signals DOPi and DONi are input to the booster circuit 6-i provided outside the semiconductor device 2. The booster circuit 6-i boosts the PWM signals DOPi and DONi to generate drive signals DOXPi and DOXNi, and outputs the drive signals DOXPi and DOXNi to the sound output unit 7-i. For example, the booster circuit 6-i boosts the PWM signals DOP1 and DON1 to generate drive signals DOXP1 and DOXN1 for driving the sound output unit 7-1, and the booster circuit 6-2 boosts the PWM signals DOP2 and DON2 to generate drive signals DOXP2 and DOXN2 for driving the sound output unit 7-2.

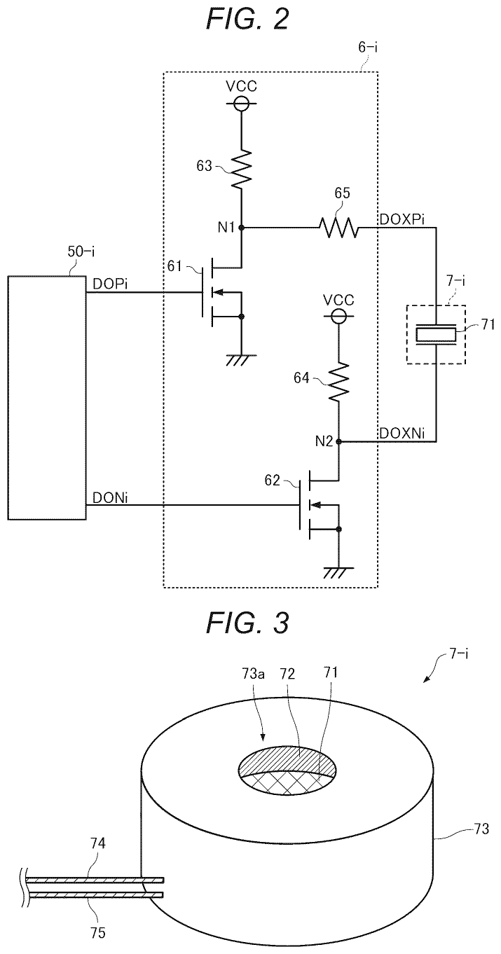

FIG. 2 shows a configuration example of the booster circuit 6-i. As shown in FIG. 2, the booster circuit 6-i includes N-channel MOSFETs 61 and 62 and resistors 63, 64, and 65. The MOSFET is an abbreviation for Metal Oxide Semiconductor Field Effect Transistor.

MOSFET 61 has a drain coupled to a node N1, a source coupled to a ground node, and a gate to which the PWM signal DOPi is input from the PWM signal generation circuit 50-i. MOSFET 62 has a drain coupled to a node N2, a source coupled to a ground node, and a gate to which the PWM signal DONi is input from the PWM signal generation circuit 50-1.

The resistor 63 has one end coupled to a power supply node and the other end coupled to the node N1. The power supply node is a node to which a power supply voltage VCC is supplied. The resistor 64 has one end coupled to a power supply node and the other end coupled to the node N2. The resistor 65 has one end coupled to the node N1, and the other end from which the drive signal DOXPi is output. The drive signal DOXNi is output from the node N2.

In the booster circuit 6-i having the above-described configuration, when the PWM signal DOPi is a high-level voltage and the PWM signal DONi is a low-level voltage, the MOSFET 61 is turned on and the drive signal DOXPi becomes a low-level voltage, and the MOSFET 62 is turned off and the drive signal DOXNi becomes a high-level voltage. When the PWM signal DOPi is a low-level voltage and the PWM signal DONi is a high-level voltage, MOSFET 61 is turned off and the drive signal DOXPi becomes a high-level voltage, and MOSFET 62 is turned on and the drive signal DOXNi becomes a low-level voltage. That is, one of the drive signal DOXPi and the drive signal DOXNi is at a high level, and the other is at a low level. Here, the high-level voltages of the drive signals DOXPi and DOXNi are power supply voltages VCC, and the low-level voltages of the drive signals DOXPi and DOXNi are ground voltages (0 V). Therefore, one of the drive signal DOXPi and the drive signal DOXNi becomes the power supply voltage VCC, and the other becomes 0 V.

Although the details will be described later, the sound output unit 7-i includes a piezoelectric element 71, and deforms the piezoelectric element 71 by the drive signals DOXPi and DOXNi to generate a sound. Therefore, the other end of the resistor 65 from which the drive signal DOXPi is output and the node N2 from which the drive signal DOXNi is output are coupled to one end and the other end of the piezoelectric element 71 of the sound output unit 7-i, respectively. Since one of the drive signals DOXPi and DOXNi becomes the power supply voltage VCC and the other becomes 0 V, a potential difference corresponding to the power supply voltage VCC is generated between the ends of the piezoelectric element 71. In order to sufficiently deform the piezoelectric element 71, the power supply voltage VCC is set to, for example, a dozen volts.

Referring back to FIG. 1, each of the sound output units 7-1 to 7-n is a device that outputs a sound. Specifically, the sound output unit 7-i outputs a sound corresponding to the input drive signals DOXPi and DOXNi. i is an integer from one to n. The sound output from the sound output unit 7-i may be a voice or a sound other than a voice. The sound output unit 7-i can output various types of information such as attention calling and guidance as voice or sound. The sound output units 7-1 to 7-n have different resonance frequencies from one another and thus have different sizes, but may have the same basic structure.

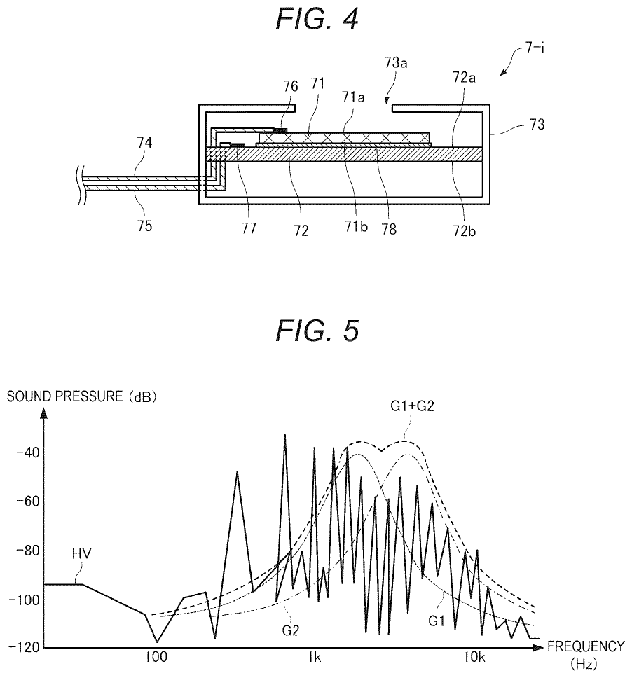

FIGS. 3 and 4 show an example of the structure of the sound output unit 7-i. FIG. 3 is a perspective view of the sound output unit 7-i, and FIG. 4 is a cross-sectional view of the sound output unit 7-i. As shown in FIGS. 3 and 4, the sound output unit 7-i includes the piezoelectric element 71 and a diaphragm 72. The diaphragm 72 is a disk-shaped metal plate having a first surface 72a and a second surface 72b. The piezoelectric element 71 includes a first surface 71a and a second surface 71b, and has a disk shape having a diameter smaller than that of the diaphragm 72. A wire 74 is bonded to the first surface 71a of the piezoelectric element 71 by a conductive bonding member 76, and the second surface 71b of the piezoelectric element 71 is bonded to the first surface 72a of the diaphragm 72 by a conductive bonding member 78. A wire 75 is bonded to the first surface 72a of the diaphragm 72 by a conductive bonding member 77. The bonding members 76, 77, and 78 are, for example, solder.

As shown in FIGS. 3 and 4, the sound output unit 7-i may include a housing 73 housing the piezoelectric element 71 and the diaphragm 72. The wires 74 and 75 extend from the inside to the outside of the housing 73. The drive signals DOXPi and DOXNi propagate through the wires 74 and 75, respectively. Therefore, the drive signal DOXPi propagated through the wire 74 and the bonding member 76 is applied to the first surface 71a of the piezoelectric element 71, and the drive signal DOXNi propagated through the wire 75, the bonding member 77, and the first surface 72a of the diaphragm 72 is applied to the second surface 71b of the piezoelectric element 71. The first surface 71a and the second surface 71b of the piezoelectric element 71 correspond to the one end and the other end of the piezoelectric element 71 shown in FIG. 2, respectively. Since the drive signal DOXPi and the drive signal DOXNi are in opposite phase, the piezoelectric element 71 is deformed and the diaphragm 72 vibrates according to the deformation of the piezoelectric element 71.

The diaphragm 72 vibrates, and thereby, the surrounding air vibrates to generate a sound. However, the sound generated by the vibration of the diaphragm 72 is small, and the sound is resonated and amplified by the housing 73. That is, the housing 73 functions as a resonance box. The amplified sound propagates to the outside from an opening 73a of the housing 73. In order to enhance the resonance effect, the resonance frequency of the diaphragm 72 and the resonance frequency of the housing 73 are designed to coincide with each other. The larger the diaphragm 72 and the housing 73, the lower the resonance frequency, and the smaller the diaphragm 72 and the housing 73, the higher the resonance frequency.

In the sound output unit 7-i having the above-described structure, the period of the vibration of the diaphragm 72 changes according to the pulse periods of the drive signals DOXPi and DOXNi, and a sound in a narrow frequency band containing the resonance frequency can be output. However, it may be impossible for the sound output unit 7-i to output a sound containing a component of 100 Hz to several kilohertz like a human voice, for example. Therefore, in the embodiment, the n sound output units 7-1 to 7-n having different resonance frequencies from one another are controlled to output sounds in different frequency bands from one another, and these sounds are mixed in a space to reproduce a sound containing various components in a wider frequency band.

For example, a case where n=2 is taken as an example, and FIG. 5 shows an example of a relationship between human voice characteristics and sound output characteristics of the sound output units 7-1 and 7-2. In FIG. 5, the horizontal axis indicates a frequency (Hz) and the vertical axis indicates sound pressure (dB). HV indicates human voice characteristics, G1 indicates sound output characteristics of the sound output unit 7-1, and G2 indicates sound output characteristics of the sound output unit 7-2. In FIG. 5, as indicated by HV, a human voice contains various components in a wider frequency band. On the other hand, the resonance frequency of the sound output unit 7-1 is around 2 kHz, and there is a region where the sound pressure is higher in a frequency band of about 1,500 Hz to 3 kHz. The resonance frequency of the sound output unit 7-2 is around 4 kHz, and there is a region where the sound pressure is higher in a frequency band of about 3 kHz to 5 kHz. That is, the resonance frequency of the sound output unit 7-2 is higher than the resonance frequency of the sound output unit 7-1, and the frequency band that can be output by the sound output unit 7-2 is higher than the frequency band that can be output by the sound output unit 7-1. Therefore, in the embodiment, the semiconductor device 2 generates the PWM signals DOP1 and DON1 for the sound output unit 7-1 to output a low-frequency sound based on the sound data SD, and generates the PWM signals DOP2 and DON2 for the sound output unit 7-2 to output a high-frequency sound based on the sound data SD.

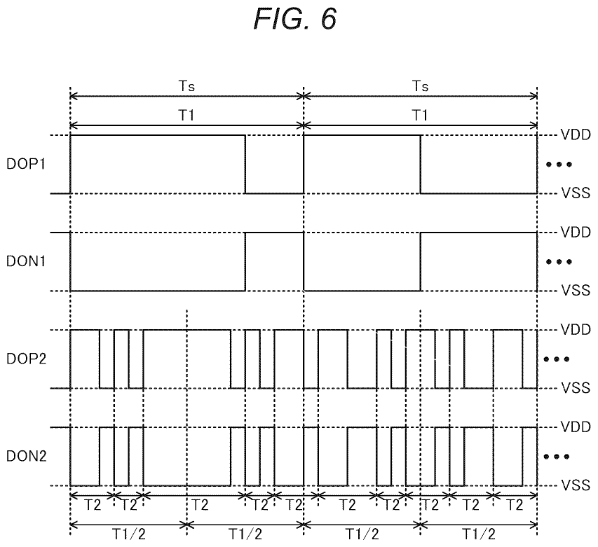

FIG. 6 shows an example of the PWM signals DOP1, DON1 and the PWM signals DOP2, DON2. As shown in FIG. 6, the high level of the PWM signals DOP1 and DON1 is at a power supply voltage VDD of the semiconductor device 2 and the low level is at a ground voltage VSS of the semiconductor device 2. Similarly, the high level of the PWM signals DOP2 and DON2 is at the power supply voltage VDD and the low level is at the ground voltage VSS. That is, the voltage amplitude of the PWM signals DOP1 and DON1 is equal to the voltage amplitude of the PWM signals DOP2 and DON2.

A pulse period T2 of the PWM signals DOP2 and DON2 for the sound output unit 7-2 to output a high-frequency sound is shorter than a pulse period T1 of the PWM signals DOP1 and DON1 for the sound output unit 7-1 to output a low-frequency sound. Specifically, the average value of the pulse periods T2 of the PWM signals DOP2 and DON2 is smaller than the average value of the pulse periods T1 of the PWM signals DOP1 and DON1. Note that the pulse period T1 is a time from when the PWM signals DOP1 and DON1 change from the low level to the high level to when the PWM signals DOP1 and DON1 change from the low level to the high level next, and the pulse period T2 is a time from when the PWM signals DOP2 and DON2 change from the low level to the high level to when the PWM signals DOP2 and DON2 change from the low level to the high level next.

In particular, in FIG. 5, as indicated by HV, the component of the peak frequency contained in the human voice is called a formant and the formants are reproduced as much as possible, and thereby, the voice is easier to be heard. Although the low frequency range of 1 kHz or less contains fewer formants and smaller noise components than those in the high frequency range, the low frequency range of 1 kHz or less is farther from the resonance frequency of the sound output unit 7-1, and thus the sound pressure is smaller as indicated by G1 in FIG. 5. Therefore, the number of times of switching of the PWM signals DOP1 and DON1 in a sampling period Ts of the sound data SD is reduced to the limit to be one, and thereby, the loss is reduced and the sound pressure is maximized. As described above, the pulse period T1 of the PWM signals DOP1 and DON1 is set to the same as the sampling period Ts, and the sound pressure is prioritized over the sound quality with respect to the low-frequency sound output by the sound output unit 7-1. That is, the PWM signals DOP1 and DON1 may be signals whose pulse widths change and whose pulse period T1 is constant. First table information for generating the PWM signals DOP1 and DON1 is created in advance, and the PWM signal generation circuit 50-1 generates the PWM signals DOP1 and DON1 based on the first table information.

On the other hand, since many formants are high-frequency components of 1 kHz or more, it may be possible to reproduce a sound close to human voice by reproducing the high-frequency components. The high frequency of 1 kHz or more is close to the resonance frequency of the sound output unit 7-2, and the sound pressure is larger as indicated by G2 in FIG. 5. However, a noise component is likely to be superimposed on the high frequency band. For reduction of the high frequency noise component, the PWM signals DOP2 and DON2 are signals whose pulse width and pulse period T2 change and are switched at a plurality of times in the sampling period Ts of the sound data SD. As described above, the sound pressure of the high-frequency sound output by the sound output unit 7-2 is secured, and the sound quality is prioritized over the sound pressure by setting the pulse period T2 of the PWM signals DOP2 and DON2 to be shorter than the sampling period Ts. Further, as shown in FIG. 6, the pulse width modulation signals DOP2 and DON2 may be signals whose waveforms are symmetrical before and after a half period of the pulse period T1 of the pulse width modulation signals DOP1 and DON1. Accordingly, a steep change in the sound pressure output by the sound output unit 7-2 is suppressed, and thus harmonic distortion can be suppressed. Second table information for generating the PWM signals DOP2 and DON2 for reducing such noise components and harmonic distortion is created in advance, and the PWM signal generation circuit 50-2 generates the PWM signals DOP2 and DON2 based on the second table information.

Note that band-pass filter processing or low-pass filter processing for the sound data SD is incorporated in the first table information and the second table information so that folding noise is not superimposed on the PWM signals DOP1 and DON1 and the PWM signals DOP2 and DON2. As described above, by incorporating the noise reduction processing or the filter processing into the table information, a filter circuit or a sigma-delta modulation circuit for reducing noise is not required upstream of the PWM signal generation circuits 50-1 to 50-n, and thus the circuit scale of the semiconductor device 2 is reduced. Further, since a sigma-delta modulation circuit that operates with a clock signal of a high frequency is unnecessary, power consumption of the semiconductor device 2 is reduced.

The semiconductor device 2 outputs the PWM signals DOP1 and DON1 and the PWM signals DOP2 and DON2 in the same period, and thereby, the low-frequency sound output by the sound output unit 7-1 and the high-frequency sound output by the sound output unit 7-2 are mixed in a space, and a sound containing various components in a wider frequency band contained in the sound data SD is reproduced. That is, as shown in FIG. 5, the two sound output units 7-1 and 7-2 function as pseudo speakers having sound output characteristics obtained by synthesis of the sound output characteristics G1 and G2. Therefore, the sound reproduction apparatus 1 including the semiconductor device 2 and the sound output units 7-1 and 7-2 can reproduce sound data such as human voice data and melody data. Further, the sound reproduction apparatus 1 can support reproduction of voice data of various languages having different frequency bands.

Note that the PWM signals DOP1 and DON1 are examples of “first pulse width modulation signal”, and the PWM signals DOP2 and DON2 are examples of “second pulse width modulation signal”. The PWM signal generation circuit 50-1 is an example of “first pulse width modulation signal generation circuit”, and the PWM signal generation circuit 50-2 is an example of “second pulse width modulation signal generation circuit”. The sound output unit 7-1 is an example of “first sound output unit”, and the sound output unit 7-2 is an example of “second sound output unit”. The piezoelectric element 71 of the sound output unit 7-1 is an example of “first piezoelectric element”, and the piezoelectric element 71 of the sound output unit 7-2 is an example of “second piezoelectric element”. The diaphragm 72 of the sound output unit 7-1 is an example of “first diaphragm”, and the diaphragm 72 of the sound output unit 7-2 is an example of “second diaphragm”. The booster circuit 6-1 is an example of “first booster circuit”, and the booster circuit 6-2 is an example of “second booster circuit”. The drive signals DOXP1 and DOXN1 are examples of “first drive signal”, and the drive signals DOXP2 and DOXN2 are examples of “second drive signal”.

As described above, in the semiconductor device 2 and the sound reproduction apparatus 1 of the first embodiment, the sound output units 7-1 to 7-n having different resonance frequencies from one another are controlled to output sounds having different frequencies from one another by the PWM signals DOP1, DON1 to DOPn, and DONn, and thereby, the frequency band that can be output can be widened as a whole. Further, in the semiconductor device 2 and the sound reproduction apparatus 1 of the first embodiment, the PWM signals DOP1, DON1 to DOPn, and DONn optimal for the sound output characteristics of the sound output units 7-1 to 7-n can be generated based on one piece of sound data SD. Therefore, according to the semiconductor device 2 and the sound reproduction apparatus 1 of the first embodiment, the n sound output units 7-1 to 7-n that can output narrower frequency bands can be controlled to output high-quality sounds.

### 1-2. Second Embodiment

Hererinafter, regarding a semiconductor device 2 and a sound reproduction apparatus 1 according to a second embodiment, the same configurations as those of the first embodiment will have the same signs and the same descriptions as those of the first embodiment will be omitted or simplified, and the configurations different from those of the first embodiment will be mainly described.

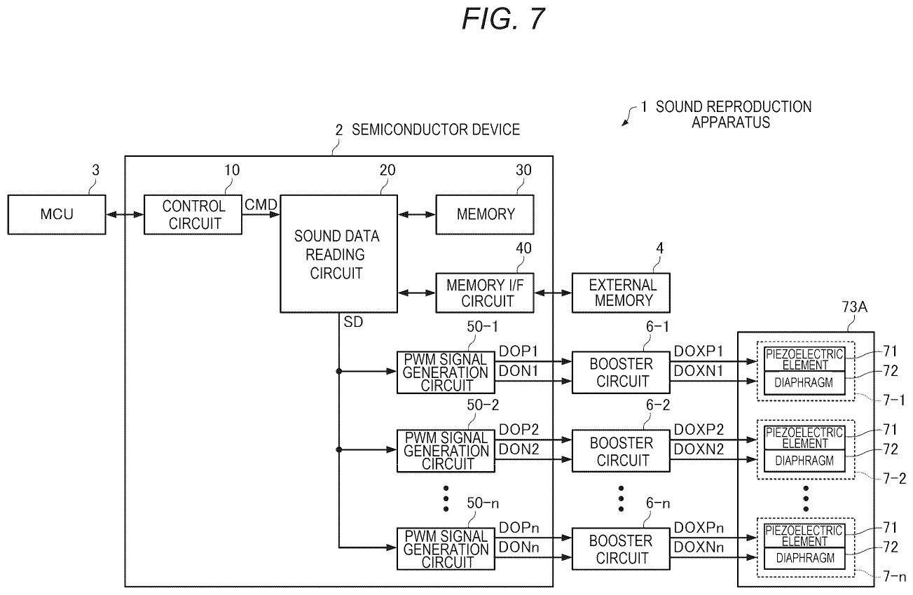

FIG. 7 shows a configuration example of the semiconductor device 2 and the sound reproduction apparatus 1 of the second embodiment. As shown in FIG. 7, similarly to the first embodiment, the sound reproduction apparatus 1 of the second embodiment includes the semiconductor device 2, the MCU 3, the external memory 4, the n booster circuits 6-1 to 6-n, and the n sound output units 7-1 to 7-n. Since the configurations and functions of the semiconductor device 2, the MCU 3, the external memory 4, and the booster circuits 6-1 to 6-n are the same as those of the first embodiment, the description thereof will be omitted.

As shown in FIG. 7, in the second embodiment, similarly to the first embodiment, each of the sound output units 7-1 to 7-n includes the piezoelectric element 71 and the diaphragm 72, however, the sound output units 7-1 to 7-n are housed in one housing 73A. Further, drive signals DOXPi and DOXNi are supplied to the sound output unit 7-i. i is an integer from one to n. For example, when n=2, the sound output units 7-1 and 7-2 each include the piezoelectric element 71 and the diaphragm 72 shown in FIGS. 3 and 4, however, housed in the single housing 73A without the housings 73. The drive signals DOXP1 and DOXN1 are respectively supplied to one end and the other end of the piezoelectric element 71 of the sound output unit 7-1 housed in the housing 73A, and the drive signals DOXP2 and DOXN2 are respectively supplied to one end and the other end of the piezoelectric element 71 of the sound output unit 7-2 housed in the housing 73A.

The resonance frequency of the housing 73A may be different from the resonance frequency of any sound output units 7-1 to 7-n or may be the same as the resonance frequency of one of the sound output units 7-1 to 7-n. In the former case, the resonance frequency of the housing 73A is set to be the same as a frequency at small sound pressure in the sound output characteristics obtained by synthesis of the sound output characteristics of the sound output units 7-1 to 7-n, and thereby, a clear sound is output in a wider frequency band. In the latter case, with the resonance frequency of the housing 73A, a sound further emphasized at a predetermined frequency is output.

In addition, according to the semiconductor device 2 and the sound reproduction apparatus 1 of the second embodiment, the same effects as those of the semiconductor device 2 and the sound reproduction apparatus 1 of the first embodiment are exerted.

### 1-3. Modification Examples

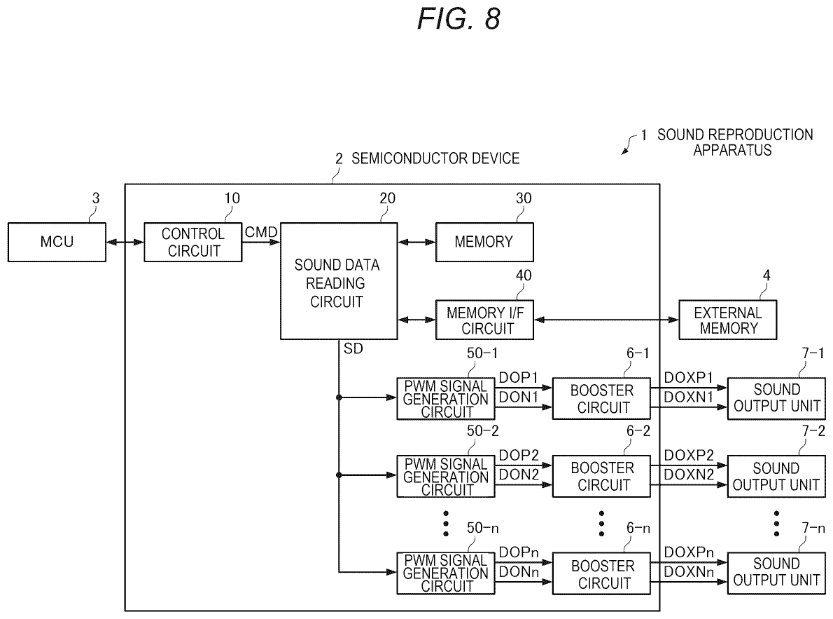

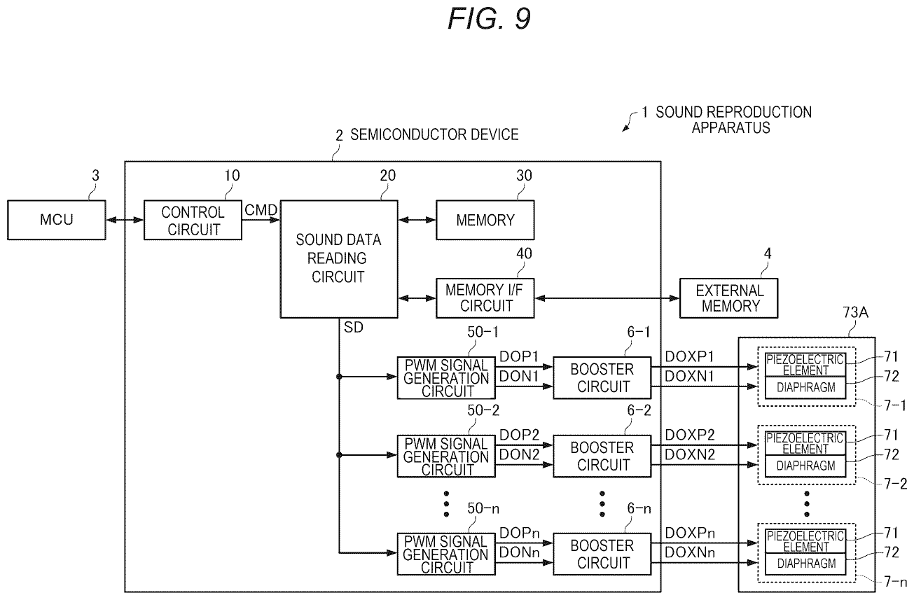

In the above-described first embodiment, the booster circuits 6-1 to 6-n are provided outside the semiconductor device 2, however, as shown in FIG. 8, the semiconductor device 2 may include the booster circuits 6-1 to 6-n. Similarly, in the above-described second embodiment, the booster circuits 6-1 to 6-n are provided outside the semiconductor device 2, however, as shown in FIG. 9, the semiconductor device 2 may include the booster circuits 6-1 to 6-n.

In the above-described respective embodiments, the PWM signal DOPi and the drive signal DOXPi are signals in opposite phase, and the PWM signal DONi and the drive signal DOXNi are signals in opposite phase, however, the PWM signal DOPi and the drive signal DOXPi may be signals in phase, and the PWM signal DONi and the drive signal DOXNi may be signals in phase.

### 2. Electronic Apparatus

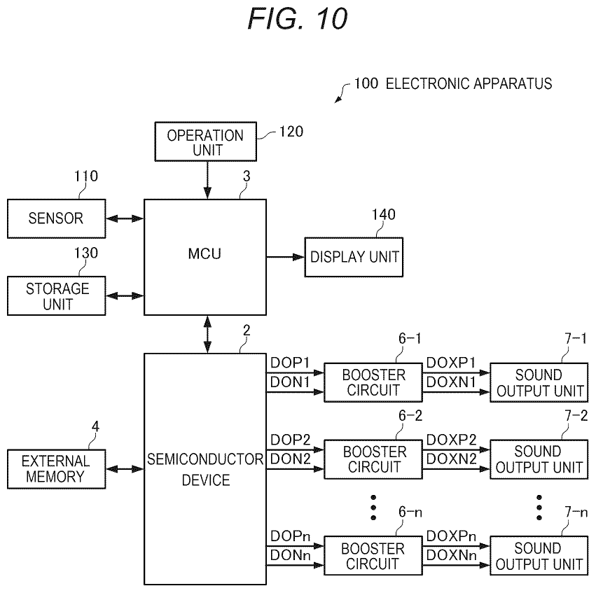

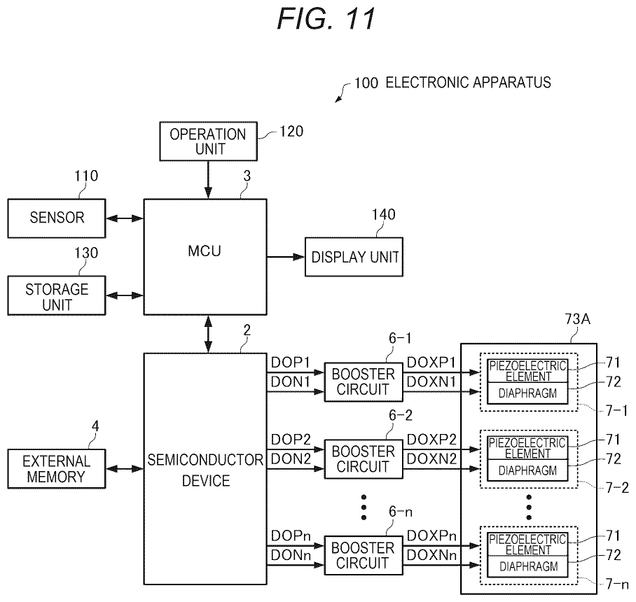

FIG. 10 is a functional block diagram showing a configuration example of an electronic apparatus using the semiconductor device 2 of the above-described first embodiment. FIG. 11 is a functional block diagram showing a configuration example of an electronic apparatus using the semiconductor device 2 of the above-described second embodiment. In FIG. 10, the same component elements as those in FIG. 1 have the same signs. Similarly, in FIG. 11, the same component elements as those in FIG. 7 have the same signs.

As shown in FIGS. 10 and 11, an electronic apparatus 100 of the embodiment includes the semiconductor device 2, the MCU 3, the external memory 4, n booster circuits 6-1 to 6-n, n sound output units 7-1 to 7-n, a sensor 110, an operation unit 120, a storage unit 130, and a display unit 140. Note that the electronic apparatus 100 of the embodiment may have a configuration in which part of the component elements shown in FIG. 10 or FIG. 11 is omitted or changed, or another component element is added.

The external memory 4 stores various types of sound data including voice data such as attention calling or guidance, or audio data such as a melody. Further, similar various types of sound data are stored in the memory 30 inside the semiconductor device 2 shown in FIG. 1.

The MCU 3 performs control processing of each unit of the electronic apparatus 100 and various kinds of data processing. For example, the MCU 3 transmits various commands to the semiconductor device 2 and controls the operation of the semiconductor device 2. The MCU 3 performs various kinds of processing according to detection signals from the sensor 110, various kinds of processing according to operation signals from the operation unit 120, processing of transmitting a display signal for displaying various types of information on the display unit 140, and the like.

The sensor 110 is any sensor such as an acceleration sensor, an angular velocity sensor, a velocity sensor, a pressure sensor, or a temperature sensor, and outputs a detection signal to the MCU 3.

The operation unit 120 is an input device including operation keys, button switches, and the like, and outputs an operation signal in response to a user's operation to the MCU 3.

The storage unit 130 stores programs, data, and the like for the MCU 3 to perform various kinds of calculation processing and control processing. The storage unit 130 is implemented by, for example, a hard disk, a flexible disk, an MO, an MT, various memories, a CD-ROM, a DVD-ROM, or the like.

The display unit 140 is a display device including an LCD or the like, and displays various types of information based on the input display signal. The LCD is an abbreviation for Liquid Crystal Display. The display unit 140 may be provided with a touch panel that functions as the operation unit 120.

The semiconductor device 2 generates PWM signals DOP1, DON1 to DOPn, and DONn based on various commands transmitted from the MCU 3, and outputs the PWM signals to the booster circuits 6-1 to 6-n. The booster circuits 6-1 to 6-n output the drive signals DOXP1, DOXN1 to DOXPn, and DOXNn obtained by boosting of the PWM signals DOP1, DON1 to DOPn, and DONn to the sound output units 7-1 to 7-n, respectively. The sound output units 7-1 to 7-n output sounds in response to the drive signals DOXP1, DOXN1 to DOXPn, and DOXNn, respectively.

For example, the MCU 3 may transmit a command for instructing to reproduce a voice for calling attention to the semiconductor device 2 based on the detection signal from the sensor 110. Further, for example, the MCU 3 may transmit a command for instructing to reproduce a voice for guidance to the semiconductor device 2 based on the operation signal from the operation unit 120. Furthermore, for example, the MCU 3 may transmit a command for reproducing predetermined sound or melody data to the semiconductor device 2 at predetermined timing. The semiconductor device 2 reads the corresponding sound data from the external memory 4 or the internal memory 30 and generates the PWM signals DOP1, DON1 to DOPn, and DONn. Then, the sounds output by the sound output units 7-1 to 7-n based on the PWM signals DOP1, DON1 to DOPn, and DONn are mixed in a space, and thereby, a sound such as a voice or a melody containing various components in a wider frequency band is reproduced.

In the electronic apparatus 100 in FIG. 10 or FIG. 11, the booster circuits 6-1 to 6-n may be built in the semiconductor device 2. That is, the electronic apparatus 100 may include the semiconductor device 2 shown in FIG. 8 or FIG. 9. In the electronic apparatus 100 in FIG. 11, without the housing 73A, the sound generated by the vibration of the diaphragms 72 of the respective sound output units 7-1 to 7-n may be resonated and amplified by the housing of the electronic apparatus 100. That is, the housing of the electronic apparatus 100 may function as a resonance box.

Various electronic apparatuses are conceivable as the electronic apparatus 100, and examples thereof include a warning device, various home electrical appliances such as a rice cooker, an IH cooking heater, a vacuum cleaner, and a washing machine, an electronic timepiece, a personal computer such as mobile type, laptop type, and tablet type, a mobile terminal such as a smartphone and a mobile telephone, a digital camera, an inkjet type ejection device such as an inkjet printer, a storage area network device such as a router and a switch, a local area network device, a mobile terminal base station device, a television, a video camera, a video recorder, a car navigation device, a real-time clock device, a pager, an electronic organizer, an electronic dictionary, a calculator, an electronic game device, a game controller, a word processor, a workstation, a videophone, a security television monitor, electronic binoculars, a POS terminal, a medical device such as an electronic thermometer, a blood pressure meter, a blood sugar meter, an electrocardiogram measuring device, an ultrasonic diagnostic device, and an electronic endoscope, a fish finder, various measuring devices, measuring instruments of a vehicle, an aircraft, a ship, and the like, a flight simulator, a head-mounted display, a motion trace, a motion tracking, a motion controller, and a pedestrian dead reckoning device.

The present disclosure is not limited to the embodiments, and various modifications can be made within the scope of the gist of the present disclosure.

The above-described embodiments and modification examples are merely examples, and the present disclosure is not limited thereto. For example, the embodiments and modification examples may be combined as appropriate.

The present disclosure includes substantially the same configurations as the configurations described in the embodiments, for example, configurations having the same functions, methods, and results or configurations having the same purposes and effects. The present disclosure includes a configuration in which a non-essential portion of the configuration described in the embodiment is replaced. Further, the present disclosure includes a configuration that exerts the same function and effect or a configuration that can achieve the same purpose as the configurations described in the embodiments. Furthermore, the present disclosure includes a configuration with the addition of a known technique to the configuration described in the embodiments.

The following configurations are derived from the above-described embodiments and the modification examples.

A semiconductor device according to an aspect includes a sound data reading circuit that reads sound data from a memory, a first pulse width modulation signal generation circuit that generates a first pulse width modulation signal whose pulse width changes based on the sound data, and a second pulse width modulation signal generation circuit that generates a second pulse width modulation signal whose pulse width changes based on the sound data, wherein the first pulse width modulation signal is a signal for a first sound output unit including a first piezoelectric element and a first diaphragm to output a sound, and the second pulse width modulation signal is a signal for a second sound output unit including a second piezoelectric element and a second diaphragm and having a higher resonance frequency than the first sound output unit to output a sound.

In the semiconductor device, the first sound output unit and the second sound output unit having different resonance frequencies are controlled to output sounds having different frequencies by the first pulse width modulation signal and the second pulse width modulation signal, and thereby, the frequency band that can be output can be widened as a whole. Further, in the semiconductor device, the first pulse width modulation signal optimal for the sound output characteristics of the first sound output unit can be generated and the second pulse width modulation signal optimal for the sound output characteristics of the second sound output unit can be generated based on one piece of sound data. Therefore, according to the semiconductor device, the two sound output units having narrower frequency bands that can be output can be controlled to output high-quality sounds.

In the semiconductor device of the aspect, the first pulse width modulation signal may be a signal whose pulse width changes and whose pulse period is constant, and the second pulse width modulation signal may be a signal whose pulse width and pulse period change.

According to the semiconductor device, since the second pulse width modulation signal with reduced high-frequency noise can be generated, the second sound output unit can be controlled to output a high-quality sound.

In the semiconductor device of the aspect, the second pulse width modulation signal may be a signal whose waveform is symmetrical before and after a half period of a pulse period of the first pulse width modulation signal.

According to the semiconductor device, since a steep change in the sound pressure output by the second sound output unit is suppressed, harmonic distortion can be suppressed.

In the semiconductor device of the aspect, an average value of pulse periods of the second pulse width modulation signal may be smaller than an average value of pulse periods of the first pulse width modulation signal.

In the semiconductor device of the aspect, a voltage amplitude of the first pulse width modulation signal may be equal to a voltage amplitude of the second pulse width modulation signal.

The semiconductor device of the aspect may further include a first booster circuit that boosts the first pulse width modulation signal to generate a first drive signal for driving the first sound output unit, and a second booster circuit that boosts the second pulse width modulation signal to generate a second drive signal for driving the second sound output unit.

According to the semiconductor device, the sound pressure output from the two sound output units can be increased.

In the semiconductor device of the aspect, the first sound output unit and the second sound output unit may be housed in one housing.

According to the semiconductor device, the resonance frequency of the housing is set to be the same as a frequency at small sound pressure, and thereby, a clear sound is output in a wider frequency band. Alternatively, the resonance frequency of the housing is set to be the same as the resonance frequency of the first sound output unit or the resonance frequency of the second sound output unit, and thereby, a sound further emphasized at a predetermined frequency is output.

An electronic apparatus according to an aspect includes the semiconductor device of the aspect, the first sound output unit, and the second sound output unit.

What is claimed is:

1. A semiconductor device comprising:
a sound data reading circuit that reads sound data from a memory;
a first pulse width modulation signal generation circuit that generates a first pulse width modulation signal whose pulse width changes based on the sound data; and
a second pulse width modulation signal generation circuit that generates a second pulse width modulation signal whose pulse width changes based on the sound data, wherein
the first pulse width modulation signal is a signal for a first sound output unit including a first piezoelectric element and a first diaphragm to output a sound, and
the second pulse width modulation signal is a signal for a second sound output unit including a second piezoelectric element and a second diaphragm and having a higher resonance frequency than the first sound output unit to output a sound.

2. The semiconductor device according to claim 1, wherein
the first pulse width modulation signal is a signal whose pulse width changes and whose pulse period is constant, and
the second pulse width modulation signal is a signal whose pulse width and pulse period change.

3. The semiconductor device according to claim 1, wherein
the second pulse width modulation signal is a signal whose waveform is symmetrical before and after a half period of a pulse period of the first pulse width modulation signal.

4. The semiconductor device according to claim 1, wherein
an average value of pulse periods of the second pulse width modulation signal is smaller than an average value of pulse periods of the first pulse width modulation signal.

5. The semiconductor device according to claim 1, wherein
a voltage amplitude of the first pulse width modulation signal is equal to a voltage amplitude of the second pulse width modulation signal.

6. The semiconductor device according to claim 1, further comprising:
a first booster circuit that boosts the first pulse width modulation signal to generate a first drive signal for driving the first sound output unit; and
a second booster circuit that boosts the second pulse width modulation signal to generate a second drive signal for driving the second sound output unit.

7. The semiconductor device according to claim 1, wherein
the first sound output unit and the second sound output unit are housed in one housing.

8. An electronic apparatus comprising:
the semiconductor device according to claim 1;
the first sound output unit; and
the second sound output unit.
